(19) United States
(12) Patent Application Publication
(10) Pub. No.: US 2005/0157331 A1
(43) Pub. Date: Jul. 21, 2005

(54) Photo provider system, photo providing method, print order reception apparatus and printer

(75) Inventor: Teruyoshi Nakashima, Saitama (JP)

Correspondence Address: SUGHRUE MION, PLLC, 2100 PENNSYLVANIA AVENUE, N.W., SUITE 800, WASHINGTON, DC, 20037, US

(73) Assignee: Fuji Photo Film Co., Ltd.

(21) Appl. No.: 11/033,267

(22) Filed: Jan. 12, 2005

(30) Foreign Application Priority Data
Jan. 13, 2004 (JP) 2004-005080

(51) Int. Cl. G06F 3/12; H04B 7/00; H04N 5/225

(52) U.S. Cl. 358/1.15; 358/1.18; 348/207.1; 455/66.1; 455/41.3

(57) ABSTRACT

A photo provider system consists of an order reception server and a number of printers, and is installed in such recreational facilities as an amusement park. The printers are placed in individual Areas of the recreational facilities. The order reception server receives print orders of the photographed images from a camera that serves as a portable print order terminal for a visitor to carry it about. The order reception server also detects the location of the camera on the basis of the position data sent from the camera and determines the area where an ordered exists. Furthermore, the order reception server composes the photographed images with ornamental images linked with attractions or characters of the determined area, and orders the nearest printer to the orderer to print the composite images.

### BACKGROUND OF THE INVENTION

1. Field of the Invention

The present invention relates to a photo provider system and a photo providing method that receives print orders of photographed images taken in play facilities and offer photo prints to visitors, as well as to a print order reception apparatus and a printer for this service.

2. Description Related to the Prior Art

An intra-plant photo provider system that lends visitors cameras at such recreational facilities as an amusement park and receives print orders by gaining images photographed by the cameras through a radio communication network is known for example from Japanese Laid-open Patent Application No. 2001-309284. The system allows visitors not only to order printing of photographed images taken in play facilities on the spot but also to receive finished photo prints in returning the cameras.

Meanwhile, some researches indicate that most visitors take photos in memory and many of them hope the values as a memorial to visit are added to the photos by putting some ornaments related to the place on them. However the aforementioned intra-plant photo provider system just prints the photographed images, but does not serve these visitor's demands. In addition, although there are multiple attractions and restaurants in amusement facilities, visitors have to wait for popular ones for a very long time. The prolonged waiting time causes visitor's great mental pain and some effective solutions are required to alleviate the suffering.

### SUMMARY OF THE INVENTION

An object of the present invention is to provide a photo provider system and a photo providing method, which enrich a memorial value of the photos taken by visitors in amusement facilities.

Another object of the present invention is to provide a photo provider system and a photo providing method, which alleviate visitor's mental suffering from waiting time in amusement facilities as well as to provide a print order reception apparatus and a printer for this service.

According to the present invention, a photo provider system for providing visitors to particular play facilities with photo prints which are made from images photographed by the visitors, comprises
at least a printer installed in the play facilities, for making the photo prints; order sending terminals for sending print order data through radio communication, the print order data including data of images photographed by the visitors; and
a print order reception apparatus comprising a radio communication device that receives the print order data from the order sending thermals and sends data of images to print to the printer, a data storage device for storing ornamental images relating to the play facilities, and an image composer for composing one of the images photographed by the visitors with one of the ornamental images, wherein data of a composite image as composed in the image composer is sent to the printer, to print the composite image.

According to a preferred embodiment, the ornamental images include many kinds of ornamental images which differ from one area to another of the play facilities, and the order sending terminal sends position data to the print order reception apparatus, so that the print order reception apparatus determines based on the position data a nearest one of the areas to the order sending terminal, and chooses those of the ornamental images which are allocated to the determined area, for the image composition.

The order sending terminal is preferably attached to a camera that is carried about by the visitor. Then the print order reception apparatus detects the present position of a visitor who sends a print order on the basis of the position data received from the order sending terminal.

According to another preferred embodiment, a number of the printers are installed in different areas of the play facilities, and the order sending terminal sends position data to the print order reception apparatus, so the print order reception apparatus determines based on the position data a nearest one of the printers to the order sending terminal, and sends the data of image to print to the determined printer.

According to a further preferred embodiment, the print order reception apparatus is capable of sending data for confirmation of the composite image back to the order sending terminal through the radio communication device. In this embodiment, the print order reception apparatus sends the data for confirmation of the composite image back to the order sending terminal, and sends a command for executing a printing process to the printer upon receipt of an order confirmation from the order sending terminal.

In a photo providing method of providing visitors to particular play facilities with photo prints that are made from images photographed by the visitors, the method comprises steps of sending print order data including data of the photographed image from an order sending terminal to a print order reception apparatus through radio communication; composing the photographed image with an ornamental image that is previously stored and relating to the play facilities, and sending data of a consequent composite image to a printer that is installed in the play facilities, to print the composite image.

### BRIEF DESCRIPTION OF THE DRAWINGS

The above and other objects and advantages will be more apparent from the following detailed description of the preferred embodiments when read in connection with the accompanied drawings, wherein like reference numerals designate like or corresponding parts throughout the several views, and wherein:

FIG. 1 is a schematic diagram illustrating a photo provider system according to an embodiment of the invention;

FIG. 2 is a block diagram illustrating a print order reception server, a printer and a camera of the photo provider system; and

FIG. 3 is a flowchart illustrating a sequence of receiving a print order.

### DETAILED DESCRIPTION OF THE PREFERRED EMBODIMENTS

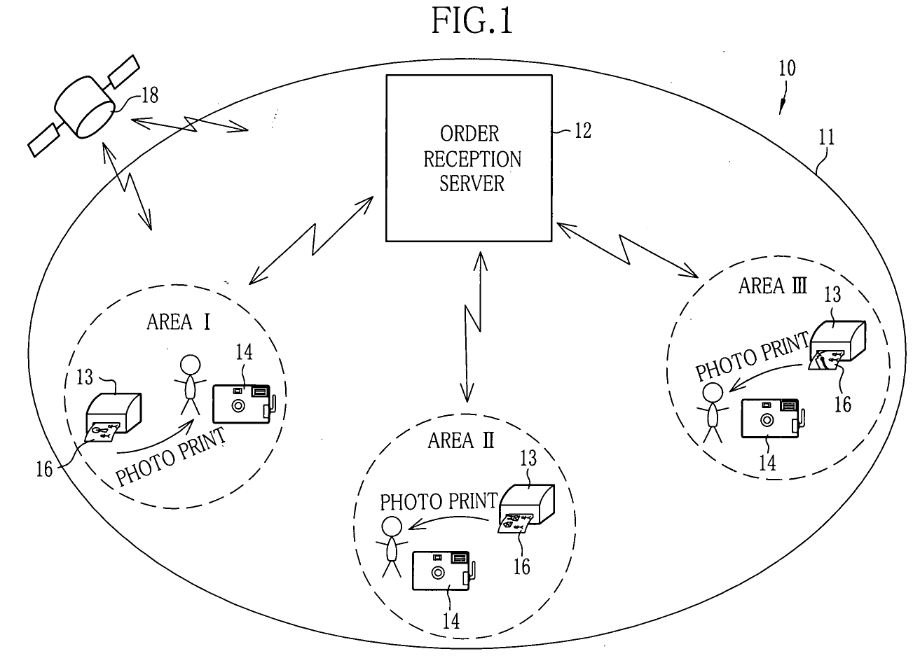

As FIG. 1 shows, a photo provider system 10 is installed in such play facilities 11 as an amusement park, receives print orders of photographed images taken by visitors in the places and provides them with photo prints 16. The photo provider system 10 consists of an order reception server 12 which receives print orders, and a number of printers 13. The play facilities 11 have a number of attractions and restaurants, which are grouped into several Areas I, II, and III, and the printers 13 are individually installed in these Areas I, II and III. For example, Area I and Area II are attraction areas where such attractions as a roller coaster and a pleasure boat exist and Area III has resting-places like restaurants and coffee shops.

Each printer 13 performs a printing process based on print orders from the order reception server 12. The order reception server 12 and each printer 13 are connected into being available for data communication through a radio network and send or receive data over the network.

Visitors can rent a digital still camera, hereinafter referred to as the camera 14, and enjoy taking photos with the camera 14 making a tour around the play facilities. The camera 14 also functions as a print order terminal with which visitors order printing of their photographed images. Visitors order printing of their photographed images taken with the camera 14 by operating the camera 14. The camera 14 can communicate with the order reception server 12 through the radio network, and the print order data including images photographed by the camera 14 is sent to the order reception server 12 over the radio network.

The camera 14 also obtains data about a present camera location by receiving radio waves coming from a global positioning system GPS satellite 18. The location data is also sent to the order reception server 12 as a part of the print order data. The order reception server 12 locates the camera 14 based on the location data, determines the nearest printer 13 and provides the print order to the determined printer 13. These procedures enable orders who send print orders to pick up photo prints 16 finished at the nearest place.

Besides, the order reception server 12 is provided with an image composition device that composes a received photographed image with a prepared ornamental image. The ornamental image includes pictorial images of attractions, constructions and landscape, as well as the name or designation and the logo of the attractions and others. A composite image with the ornament is printed and the photo print 16 is handed over to the orders.

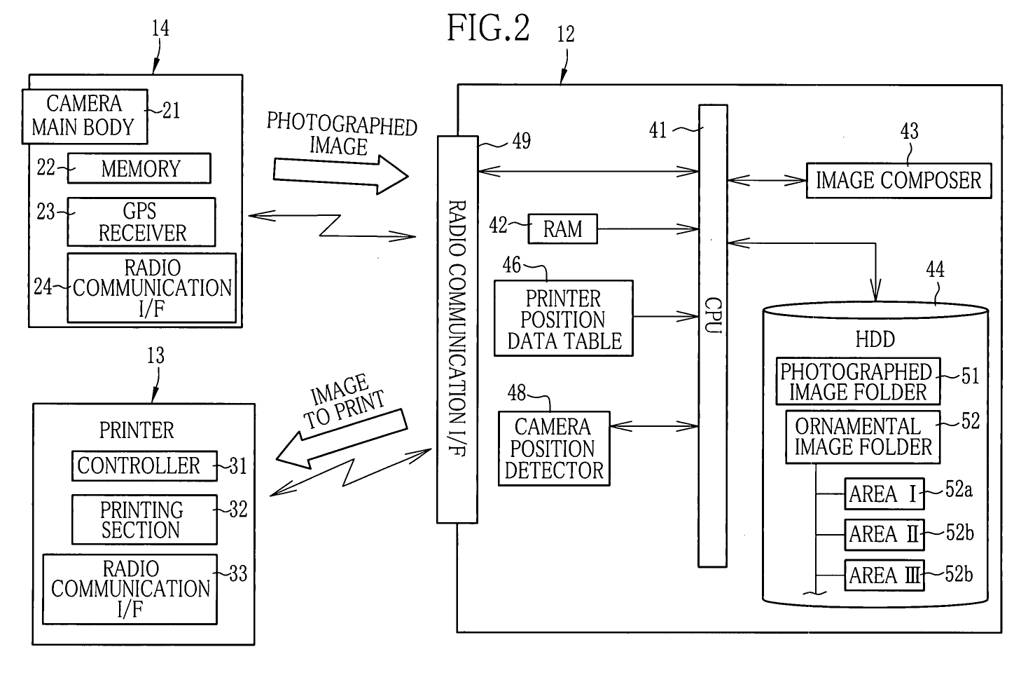

FIG. 2 is a block diagram illustrating an outline of the electrical configuration of the order reception server 12, the printer 13, and the camera 14. The camera 14 has a main body 21, a memory 22, a GPS receiver 23 and a radio communication I/F 24. The camera main body 21 consists of an imaging section including a camera lens and a CCD image sensor, an image processing section which performs various kinds of image processing such as an image quality correction and a data compression to photographed image data gained from the imaging section, a display replaying images or showing an operation screen, and a controller controlling every part of the camera 14. The memory 22 stores not only processed image data but also a pre-given camera ID.

The GPS receiver 23 receives radio waves coming from the global positioning system satellite 18 and converts them into camera position data of the latitude and longitude. The radio communication I/F 24 controls sending or receiving data between the order reception server 12 and the camera 14. Through the radio communication I/F 24, the camera positiond at a from the GPS receiver 23, the photographed image data and the camera ID in the memory 22 can be sent to the order reception server 12.

The printer 13 has a controller 31, a printing section 32 and a radio communication I/F 33. The printing section 32 consists of a feeder section loaded with sheets and a printing mechanism which runs a printing process by moving a print head based on the received image data. The printer 13 receives commands and data of images to print from the order reception server 12 through the radio communication I/F 33. The controller 31 controls every part of the printer according to the commands from the order reception server 12. When printing is finished, the controller 31 informs the order reception server 12 of the print completion through the radio communication I/F 33.

The order reception server 12 has a CPU 41, a RAM 42, an image composer 43, a storage device 44, a printer position data table 46, a camera position detector 48, and a radio communication I/F 49. The CPU 41 controls over all parts of the order reception server 12. The RAM 42 is a work memory the CPU 41 uses in executing a variety of processing. The printer position data table 46 is a table memory which connects the printer ID of each printer with Area data where it is installed. The CPU 41 determines the printer ID in a desirable Area by referring to the printer position data table 46.

The image composer 43 synthesizes a photographed image with an ornamental image. A HDD Hard Disk Drive 44 is a data storage device which keeps a large quantity of data and stores not just photographed image data ordered to print but also prepared ornamental image data. The HDD 44 has a photographed image folder 51 storing photographed images and an ornamental image folder 52 holding ornamental images. The ornamental image includes images of each attraction, names of attractions, buildings of restaurants, names and images of characters.

Kinds of the ornamental image include letters inserted above or below a photographed image, frame images encircling it, and inlay images like a character image is put in a part of it as an accent. The ornamental image folder 52 contains some sub-folders 52a, 52b and 52c which hold ornamental images grouped according to the Areas. The camera position detector 48 senses the camera location on the basis of position data of the latitude and longitude sent from the camera 14. The memory in the camera position detector 48 is provided with a lookup table which relates the data of the latitude and longitude to the respective Areas and determines which Area the camera 14 is in. The camera position detector 48 also specifies the camera ID, sends search data to the camera 14 and finds where the camera 14 is now.

When the CPU 41 receives the print order data from the camera 14, it extracts ornamental images according to the determined Area by the camera position detector 48 from the ornamental image folder 52. The image composer 43 then compounds the photographed image with the extracted ornamental image. The CPU 41 sends the composite image to the camera 14 through the radio communication I/F 49. The composite image is delivered for example, in the form of a thumbnail-sized image, smaller than the original image. When there are several ornamental images for the determined Area, several thumbnail-sized images composed with the respective ornamental images are delivered.

An order checks the thumbnail-sized images in a display of the camera 14, selects the most desirable one, and sends an order confirmation to the order reception server 12. The order confirmation also includes position data, so the CPU 41 determines the nearest printer 13 to the camera 14 from the position data and sends the nearest printer 13 data of composite images to print whose order is fixed. The data of images to print include identification data such as the camera ID, which is printed on the back of the photo prints in order to identify the orderer for them. At the completion of printing process, the printer 13 sends a notice of print completion with the camera ID to the order reception server 12. When the order reception server 12 receives the notice, it informs the camera 14 of the print completion. An attendant is always stationed at a hand-over spot where the printer 13 is installed. The attendant hands photo prints to the orderer in exchange for the cost. The attendant sends a notice of hand-over completion with the camera ID to the order reception server 12 from the printer 13 or a portable terminal.

After the CPU 41 receives the order confirmation from the camera 14, it monitors the location of the camera 14 by sending search data at regular intervals to the camera 14. This is because some of the visitors who order printing may forget receiving the finished photo prints. With this being the situation, the order reception server 12 continues to monitor the location of the camera 14 during the period from an order confirmed until a hand-over completed. In case that the visitor ordering is out of the order sending Area, the order reception server 12 sends warning to the camera 14 and encourages the visitor to pick photo prints up. Moreover, if print hand-over isn't acknowledged, the order reception server 12 may send warning at regular intervals regardless of whether the camera is out of or in the order sending Area. In case an ordered doesn't come to pick photo prints up in spite of the repeated warning, a further print order from that ordered can be prohibited until the orderer picks up the photo prints.

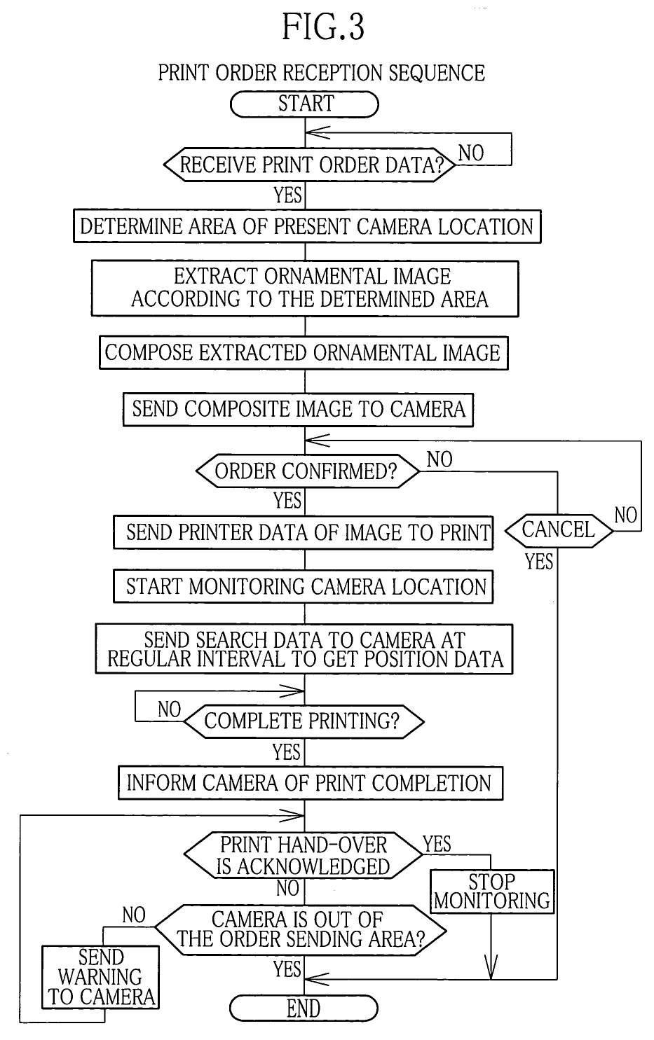

Now the operation of the above described embodiment will be explained while referring to the flowchart in FIG. 3. Visitors enjoy taking photos while touring play facilities around or waiting for more popular attractions and restaurants. They also take advantage of the waiting time to order printing of their desirable photographed images. The efficient use of the boring waiting time eases visitor's mental suffering.

When the order reception server 12 receives print order data from the camera 14, it determines the nearest Area based on the position data of the present camera location, which is included in the print order data. The order reception server 12 then extracts ornamental images according to the determined Area, synthesizes the orderer photographed images with the extracted ornamental images, and sends composite images to the camera 14. The orderer selects desirable composite images among several composite images displayed on a display of the camera 14. When there is no desirable composite image, the orderer can cancel the orders at this stage.

When some of the composite images are desirable, the orderer chooses the desirable composite images and sends the order reception server 12 an order confirmation from the camera 14. On receiving the order confirmation, the order reception server 12 extracts the printer ID associated with the position data from the printer position data table 46 and determines the nearest printer 13 to the camera 14. The order reception server 12 then sends the determined printer 13 data of images to print, to order the printer 13 to print these images. At the same time, the order reception server 12 starts monitoring the location of the camera 14.

When the printer 13 finishes printing, the order reception server 12 informs the camera 14 of print completion. The orderer receives photo prints 16 at the nearest hand-over spot. Because the photo prints 16 contain the photographed images ornamented with pictorial images or logos of relating attractions or characters, they have high value as memorial photos. As attraction goods or character goods with pictures or names of attractions or characters are very popular as a souvenir, photo prints with such ornaments can expect quite high demand.

According to the conventional photo provider system, visitors receive photo prints when they return the rental cameras. In the present invention, the print ordered can receive photo prints without returning the camera 14. According to the system of the present invention, they can retake photos and reorder printing when they are dissatisfied with the photo prints losing a necessary subject or being out of focus.

After the attendant hands photo prints 16 to the orderer, the attendant informs of the hand-over completion to the order reception server 12. Upon receiving the notice of hand-over completion, the order reception server 12 stops monitoring the camera 14.

The order reception server 12 checks if the camera 14 is out of the determined Area, when it doesn't receive a notice of hand-over completion after the lapse of predetermined time from the notice of print completion. When the camera 14 is out of the order sending Area, the order reception server 12 sends the camera 14 a warning message prompting to pick up the finished photo prints.

In the above described embodiment, the order reception server 12 synthesizes photographed images with ornamental images in response to a print order from the camera 14, and sends the camera 14 the composite images in order to allow the orderer to check them. The order reception server 12, however, may send only ornamental images to check, instead of the composite images.

In the above described embodiment, the order reception server 12 doesn't commence any action until it receives an order from the camera 14. But it is possible to promote print order by sending guidance information on the print order system to the camera. In the above described embodiment, the order reception server 12 determines the nearest Area according to the present camera location, extracts ornamental images of the determined Area, and composes photographed images with the extracted ornamental images. However it is possible to allow the visitors to choose their desirable ornamental images regardless of the camera location. For example, an ordered in the Area I can choose the ornamental images of the Area II.

In the above described embodiment, every Area has printers. The number of printers in each Area, however, may depend on the quantity of print order of the Area. It is not always necessary to install a printer in each Area: A printer can be used for some Areas or for the whole play facilities.

In the above described embodiment, the camera is provided with a terminal through which the camera can apply for print order. But it is possible to use separate print order terminals from the cameras. In this case the print order terminals must communicate data with the cameras so as to send photographed images from the camera to the print order terminal. However as there is no need for the camera to have the print order function, visitors are able to take photos with their own cameras and order prints through the photo provider system of the visited facilities.

Although the present invention has been described with respect to the preferred embodiments, the present invention is not to be limited to the above embodiments but, on the contrary, various modifications will be possible without departing from the scope and spirit of claims appended hereto.

1. A photo provider system for providing photo prints to visitors to particular play facilities, said photo prints being made from images photographed by the visitors, comprising:
at least a printer installed in the play facilities, for making the photo prints;
order sending terminals for sending print order data through radio communication, said print order data including data of images photographed by the visitors; and
a print order reception apparatus comprising a radio communication device that receives said print order data from said order sending thermals and sends data of images to print to said printer, a data storage device for storing ornamental images relating to said play facilities, and an image composer for composing one of the images photographed by the visitors with one of said ornamental images, wherein data of a composite image as composed in said image composer is sent to said printer, to print the composite image.

2. A photo provider system as claimed in claim 1, wherein said ornamental images include many kinds of ornamental images which differ from one area to another of said play facilities, and said order sending terminal sends position data to said print order reception apparatus, and wherein said print order reception apparatus comprises a device of determining based on said position data a nearest one of said areas to said order sending terminal, and chooses those of said ornamental images which are allocated to said determined area.

3. A photo provider system as claimed in claim 1, wherein said order sending terminal is attached to a camera that is carried about by the visitor.

4. A photo provider system as claimed in claim 3, wherein said print order reception apparatus detects the present position of a visitor who sends a print order on the basis of said position data received from said order sending terminal.

5. A photo provider system as claimed in claim 1, wherein a number of said printers are installed in different areas of said play facilities, and said order sending terminal sends position data to said print order reception apparatus, and wherein and said print order reception apparatus comprises a device of determining based on said position data a nearest one of said printers to said order sending terminal, and sends the data of image to print to said determined printer.

6. A photo provider system as claimed in claim 1, wherein said print order reception apparatus is capable of sending data for confirmation of said composite image back to said order sending terminal through said radio communication device.

7. A photo providing method of providing visitors to particular play facilities with photo prints that are made from images photographed by the visitors, comprising steps of:
sending print order data including data of said photographed image from an order sending terminal to a print order reception apparatus through radio communication;
composing said photographed image with an ornamental image that is previously stored and relating to said play facilities; and
sending data of a consequent composite image to a printer that is installed in said play facilities, to print said composite image.

8. A photo providing method as claimed in claim 7, further comprising steps of:
sending position data from said order sending terminal to said print order reception apparatus;
determining based on said position data a nearest one of different areas of said play facilities to said order sending terminal; and
choosing one of said ornamental images in accordance with said determined area, for the image composition.

9. A photo providing method as claimed in claim 7, further comprising steps of:
obtaining position data from said order sending terminal;
determining based on said position data a nearest one of a number of printers, which are installed in different areas of said play facilities, to said order sending terminal; and
sending data of said composite image to said determined printer.

10. A photo providing method as claimed in claim 7, further comprising steps of:
sending, after the image composition, data for confirmation of said composite image back to said order sending terminal; and
starting a printing process upon receipt of an order confirmation from said order sending terminal.

11. A print order reception apparatus used in a photo provider system for providing a visitor to particular play facilities with photo prints that are made from images photographed by a camera that the visitor carries about, said print order reception apparatus comprising:
a radio communication device for receiving print order data including data of said photographed image from an order sending terminal that is carried about by the visitor, and for sending said photographed image to a printer;
a data storage device for storing ornamental images relating to said play facilities; and
an image composer for composing said photographed image with said ornamental image.

12. A print order reception apparatus as claimed in claim 11, further comprising an ornamental image choosing device that obtains position data from said order sending terminal, determines based on said position data a nearest one of different areas of said play facilities to said order sending terminal, and chooses said ornamental image for the image composition in accordance with said determined area.

13. A print order reception apparatus as claimed in claim 11, further comprising a printer determination device that obtains position data from said order sending terminal, and determines based on said position data a nearest one of a number of printers, which are installed in different areas of said play facilities, to said order sending terminal.

14. A print order reception apparatus as claimed in claim 11, wherein said print order reception apparatus sends, after the image composition, data for confirmation of said composite image back to said order sending terminal, and sends a command for executing a printing process to said printer upon receipt of an order confirmation from said order sending terminal.

15. A printer used in a photo provider system for providing a visitor to particular play facilities with photo prints that are made from images photographed by a camera that the visitor carries about, said printer comprising:
a radio communication device for communicating with a print order reception apparatus, to execute a printing process in accordance with a print command received through said radio communication device from said print order reception apparatus.
